(19) United States
(12) Patent Application Publication
(10) Pub. No.: US 2005/0083400 A1
(43) Pub. Date: Apr. 21, 2005

(54) Three-dimensional image display device, three-dimensional image display method and three-dimensional display image data generating method

(76) Inventors: Yuzo Hirayama, Kanagawa (JP); Rieko Fukushima, Tokyo (JP); Tatsuo Saishu, Tokyo (JP); Kazuki Taira, Tokyo (JP)

Correspondence Address: Finnegan, Henderson, Farabow,;Garrett & Dunner, L.L.P., 1300 I Street, N.W., Washington, DC, 20005-3315, US

(21) Appl. No.: 10/933,420

(22) Filed: Sep. 3, 2004

(30) Foreign Application Priority Data
Sep. 4, 2003 (JP) P.2003-312748

(51) Int. Cl. H04N 7/14; H04N 9/47; H04N 13/04; H04N 15/00

(52) U.S. Cl. 348/14.07

(57) ABSTRACT

A three-dimensional image display device includes a display portion having pixels arranged in the form of a matrix in a planar display surface to have fixed horizontal and vertical pitches, a light ray control portion having first optical apertures arranged in front of the display portion to have a first pitch in a horizontal direction which limit light rays in the horizontal direction and second optical apertures to have a second pitch in a vertical direction which converge the light rays at a certain view distance, and a display drive portion which gives element images generated based on parallel projected images to pixel groups along the horizontal direction and gives image segments obtained by interleaving perspective projected images in the vertical direction. Preferably, the first pitch is equal to an integer multiple of the horizontal pitch of the pixels, and the second pitch is smaller than the vertical pitch.

### CROSS-REFERENCE TO RELATED APPLICATIONS

This application is based upon and claims the benefit of priority from the prior Japanese Patent Application No. 2003-312748, filed on Sep. 4, 2003; the entire contents of which are incorporated herein by reference.

### BACKGROUND OF THE INVENTION

1. Field of the Invention

The present invention relates to a three-dimensional image display device for displaying an image stereoscopically, a method for displaying a three-dimensional image and a method for generating image data for three-dimensional display. Particularly it relates to a three-dimensional image display device in which stereoscopic parallax can be given to both horizontal and vertical directions, a method for displaying such a three-dimensional image and a method for generating image data for such three-dimensional display.

2. Background Art

Various systems are known in a stereoscopic image display device capable of displaying a motion image stereoscopically, that is, in a so-called three-dimensional display. In the stereoscopic image display device, demand particularly for a system of the flat panel type and needing no exclusive spectacles etc. has increased in recent years. Although the theory of holography may be used in this type stereoscopic motion image display device, it is difficult to put the theory of holograph into practice. On the other hand, a system in which a light ray controller is disposed in front of a display panel (display device) having pixels located in fixed positions such as a direct-view or projection liquid crystal display device or a plasma display device is known as a system in which display of a stereoscopic motion image can be achieved relatively easily.

The light ray controller is generally called parallax barrier or parallactic barrier. The light ray controller has a structure in which different images can be viewed from one position in accordance with angles. Specifically, in a structure in which only left-right parallax (horizontal parallax) is given, slits or lenticular lenses are used. In a structure in which up-down parallax (vertical parallax) as well as the left-right parallax (horizontal parallax) is given, a pinhole or lens array is used. The system using the parallax barrier is classified into a binocular technique, a multi-view technique, a super-multi-view technique and an integral photography technique. The integral photography technique has been often called integral imaging (hereinafter abbreviated to II occasionally) recently. These basic theories are substantially equal to those invented about 100 years ago and used in stereoscopic photography.

In the simplest binocular technique, a certain view point is decided and a display panel and a parallactic barrier are arranged so that different images can be viewed from the left and right eyes in the position of the view point. The display panel has a projection surface at a distance from the viewpoint to the display panel. Two perspective projected images having the centers of perspective projection in the positions of the left and right eyes respectively are arranged alternately while vertically separated in accordance with each pixel column in the display panel. Although the binocular technique can be achieved relatively easily, there is a problem that the image cannot be viewed stereoscopically from any other position than the decided position, and that the view range is very narrow. The binocular technique also has a significant disadvantage in that an inverted stereoscopic vision, that is, an abnormal image in which projection and depth are inverted is obtained when viewed from a position moved to the left and right by the distance between the left and right eyes. Although the binocular technique has an advantage in that two-dimensional display and three-dimensional display can be switched from each other relatively easily, the binocular technique is limited to a simple field such as a small-size display.

In the multi-view technique, the number of parallax components increases in a range of from about 4 to about 8 to increase the number of normally viewing positions. When there is motion parallax, that is, when the observer moves laterally to change the viewing angle, the image in stereoscopic display can be viewed from different angles in accordance with the motion parallax. There is however a problem that the image is not continuous so that an image in which the angle changes suddenly after a dark change appears as called flipping. In the multi-view technique, there is still a problem that an inverted stereoscopic vision is obtained even in the case where the number of parallax components increases.

In the super-multi-view technique, parallactic images are not generated according to the distance between the left and right eyes but are generated so finely that light rays based on a plurality of parallactic images can enter the pupils. Because the plurality of parallactic images are input into the eyes, flipping can be eliminated so that a more natural image can be displayed. There is however a problem that it is difficult to achieve the super-multi-view technique because image information throughput increases remarkably compared with the multi-view technique. It is difficult to achieve the multi-view or super-multi-view technique because image information throughput still increases remarkably though vertical parallax as well as the horizontal parallax may be used.

The integral imaging technique (II technique) is also called integral videography technique (IV technique) or integral photography technique (IP technique). Lenses (fly's eye lenses) like insect compound eyes are used as the parallactic barrier so that element pixels corresponding to the lenses respectively, that is, element images are arranged on the back of the lenses. In the integral imaging technique (II technique), perfectly continuous motion parallax without flipping can be obtained so that light rays close to the actual light rays can be reproduced in horizontal, vertical and oblique directions. This is an ideal technique in which the image can be viewed normally stereoscopically even in the case where the observer's face is turned laterally or obliquely. When element images are to be formed from a set of discrete pixels as in a liquid crystal display device, it is necessary to use pixels high in definition of the pixel pitch. In practice, the number of pixels is limited to about 100 by about 100.

On the other hand, in a one-dimensional II technique as an II technique without vertical parallax, continuous motion parallax can be obtained in the horizontal direction. Accordingly, stereoscopic vision high in display quality can be obtained compared with the binocular or multi-view technique. Moreover, image information throughput can be reduced compared with the super-multi-view technique. It is however impossible to peep into the stereoscopic image from above and below because there is no parallax in the vertical direction.

Incidentally, when the number of parallax components in the multi-view technique is large, for example, about 16, stereoscopic vision substantially equal to that in the one-dimensional II technique can be obtained though the image is distorted in the rear and front regions which are out of the view range in the multi-view technique. That is, it can be said that the multi-view technique is a special case of the one-dimensional II technique. In a two-dimensional II technique, a three-dimensional image correctly perspective projected in accordance with the view distance can be viewed both vertically and horizontally, so that distortion does not occur. It can be said that the view range in the rear and front direction is wide compared with the one-dimensional II technique or the multi-view technique. The one-dimensional II technique in which element images are formed from discrete pixels includes the multi-view technique in terms of definition. That is, the special case of the one-dimensional II technique in which element images are formed from a relatively small number of pixels on integral-number columns, lens accuracy is high, the specific m-th pixel in n parallax components can be viewed correctly from any aperture, and the convergent interval of lines of intersection between the view distance plane and planes connecting the pixel columns to the apertures is equal to the inter-eye distance (62 to 65 mm) is equivalent to the multi-view technique. On this occasion, in the condition that the position of the view point (single eye) is fixed to a standard position, the column number difference between pixels viewed from one very front aperture and pixels viewed from an adjacent aperture is defined as the number (which may be not an integer but a decimal fraction) of pixel columns per element image. For example, this definition has been described in Hoshino at al., J. Opt. Soc. Am. A vol. 15, 2059-2065 (1998). The pitch of element images is decided on the basis of the pitch of the centers of slits projected from the view point onto the display device but is not decided on the basis of the pitch of pixels in the display device. In the multi-view technique, the centers of pixels in the display device must be located on extensions of lines connecting the two eyes to all apertures (e.g. slits), so that high design accuracy is required. If the position of the eye is shifted to the left and right, the position of the eye goes to the position where shading portions (black matrix) between pixels can be viewed. If the position of the eye is further shifted, adjacent pixels can be viewed (flipping).

On the other hand, in the one-dimensional II technique, different positions of pixels may be viewed on the extensions of lines connecting the two eyes to the apertures respectively because pixels in the display device or the black matrix are viewed. The aperture pitch and the pixel width have no relation, so that required design accuracy need not be so high. On this occasion, the fact that the aperture pitch and the pixel width have no relation is ideally on the assumption of pixel-free solid display like a photograph. Even in the case where the position of the eye is shifted, flipping does not occur because the ratio of pixels through which the openings are viewed to pixels through which the black matrix is viewed is kept constant. However, particularly when slits are used, moiré may occur if the black matrix cannot be ignored because the aperture pitch is not equal to an integer multiple of the pixel pitch when viewed from the position of the eye.

The three-dimensional image display device used in this specification does not include the multi-view technique in the horizontal direction. The one-dimensional II technique except the multi-view technique is defined as follows. That is, (1) the number of pixel columns per element image is not an integer but as large and fine as infinite, and (2) even in the case where planes connecting the pixel columns to the apertures respectively form lines of intersection so that a convergent position is provided, the convergent interval is not equal to the inter-eye distance (62 to 65 mm) and different from the view distance. In the multi-view technique, the left and right eyes view adjacent pixel columns. In the super-multi-view technique, the left and right eyes view pixels which need not be adjacent to each other but are limited. On the other hand, in the II technique, pixel columns adjacent to each other or not adjacent to each other may be viewed. This is because the II technique is originally provided on the assumption of solid images having no pixel in element images as pixel groups. In either the multi-view technique or the II technique, when the cycle of the pixel groups (element images) is compared with the cycle of apertures or slits (hereinafter simply referred to as aperture cycle) as pupils for controlling light rays, the latter (aperture cycle) is always shorter than the former (pixel group cycle) on correct design. However, in the ultimate condition having no relation to practical use, such as the case where the view distance is infinitely far or the case where the display screen is infinitely small, the latter becomes equal to the former. When the view distance is relatively far while the slits are disposed closely to the display device, the latter becomes considerably near to the former. When, for example, the view distance, the slit pitch and the gap are 1 m, 0.7 mm and 1 mm respectively, the element image cycle is 0.7007 mm which is larger by 0.1% than the slit pitch when the number of pixels in the horizontal direction is 640, the total slit width is shifted by 0.448 mm from the total width of the pixel display portion. Because the shift is relatively small, the image may look normal at a glance when the image appears in the neighbor of the center (e.g. the unfigured background is generated at opposite ends) or when the view distance is far in spite of the small display screen size even in the case where the pixel group cycle and the aperture cycle are designed to be equal to each other. It is however impossible to view the is opposite ends of the display screen correctly. Incidentally, as described above, in either the multi-view technique or the II technique, when the element image cycle (pitch) is compared with the aperture cycle (pitch), the latter is always shorter by a slight difference of about 0.1% than the former on correct design. In either the II technique or the multi-view technique, display images must be generated so that perspective projected images at the view distance can be viewed actually because the view distance is generally finite. In a general method, perspective projected images are generated (in accordance with view points and pixels) in accordance with points (lines) of intersection between the view distance plane and lines (planes) connecting the pixels (pixel columns) to the slits respectively.

When the number of parallax components in the multi-view technique is 16, lines of intersection between the view distance plane and planes connecting the pixel columns to the slits respectively converge on 16 lines. Accordingly, only 16 perspective projected images (full images) need to be generated. In the general II technique, perspective projected images (each of which need not be full but may correspond to a pixel column) must be generated for all the pixel columns because the lines of intersection do not converge. If a calculation program is generated well, the quantity of calculation per se ought to be not changed largely compared with that of the multi-view technique but the procedure is considerably complicated. Incidentally, in the special case of the II technique in which the slit pitch is equal to an integer multiple (e.g. 16 times) of the pixel pitch (though the element image pitch is larger than the slit pitch and not equal to an integer multiple of the pixel pitch), perspective projected images in the horizontal direction can be actually viewed from the view point if 16 parallel projected images are generated and distributed in accordance with the pixel columns to thereby generate a display image. However, the image viewed in this generating method becomes a strange image which is perspective projected in the horizontal direction and parallel projected in the vertical direction. Although perspective projection is a technique of projection on a predetermined plane along lines which converge on one point (viewpoint) and parallel projection is a technique of projection on a predetermined plane along parallel lines which do not converge, the “horizontal perspective and vertical parallel projection” is a technique of projection on a predetermined plane along lines which converge on one vertical line (converge in the horizontal direction but do not converge in the vertical direction). In the one-dimensional II technique, perspective projected images in accordance with the view distance are displayed in the horizontal direction but perspective projected images based on a certain view distance must be displayed in the vertical direction because vertical parallax is eliminated. Accordingly, there is a problem that the image is distorted at any other view distance than the predetermined view distance when parallel projected images in the vertical direction are combined with perspective projected images in the horizontal direction. In the binocular or multi-view technique, the obtained image becomes a false image and cannot be viewed stereoscopically from any other region than the view range in the rear-front direction. On the other hand, in the one-dimensional II technique, there is a merit that the rear-front range for stereoscopic vision is wide, but this merit cannot be used satisfactorily because of the distortion.

### SUMMARY OF THE INVENTION

As described above in detail, in the two-dimensional II technique, it is difficult to achieve high definition though parallax can be provided in horizontal and vertical directions. On the other hand, in the one-dimensional II technique, it is relatively easy to achieve high definition but there is a problem that peeping from above and below cannot be made because vertical parallax is not provided.

In consideration of such circumstances, an object of the invention is to provide a three-dimensional image display device in which a natural and high-definition stereoscopic image can be observed in accordance with the observer's motion in horizontal and vertical directions, a method for displaying such a three-dimensional image and a method for generating image data for such three-dimensional display.

The invention provides a three-dimensional image display device having a display portion including pixels arranged in the form of a matrix in a planar display surface to have fixed horizontal and vertical pitches, a light ray control portion including first and second optical apertures arranged in front of the display portion to have first and second pitches in horizontal and vertical directions respectively for limiting light rays emitted from the pixels in the horizontal and vertical directions respectively, the first pitch being decided to be equal to an integer multiple of the horizontal pitch of the pixels, the second pitch being decided to be smaller than an integer multiple of the vertical pitch of the pixels so that the second optical apertures converge light rays at a certain view distance in the vertical direction, and a display drive portion for giving element images generated based on parallel projected images to a plurality of pixel groups along the horizontal direction in accordance with the first optical apertures and giving image segments obtained by interleaving perspective projected images in the vertical direction.

In the three-dimensional image display device, a natural stereoscopic image can be observed even in the case where the observer moves horizontally. Moreover, a three-dimensional image which is discontinuous but approximately corresponds to the view position can be observed when the observer moves vertically.

In an embodiment of the three-dimensional image display device, the first optical apertures are provided as a lenticular lens sheet while the second optical apertures are provided as a slit array. Generally, when a lenticular lens sheet is used as the first optical apertures in the horizontal direction in which the number of parallax components is large, reduction in luminance can be substantially prevented. Because the number of parallax components in the vertical direction need not be large, reduction in luminance is not remarkable when a slit array is used as the second optical apertures. Moreover, when a slit array is used, the light ray control portion can be formed with high accuracy. In this manner, excellent performance can be obtained though the production method is easy.

The invention also provides a three-dimensional image display method used in a device including a display portion having pixels arranged in the form of a matrix in a planar display surface to have fixed horizontal and vertical pitches, and a light ray control portion having first and second optical apertures arranged in front of the display portion to have first and second pitches in horizontal and vertical directions respectively for limiting light rays emitted from the pixels in the horizontal and vertical directions respectively, the first pitch being decided to be equal to an integer multiple of the horizontal pitch of the pixels, the second pitch being decided to be smaller than an integer multiple of the vertical pitch of the pixels so that the second optical apertures converge light rays at a certain view distance in the vertical direction, the method including the steps of giving element images generated based on parallel projected images to a plurality of pixel groups along the horizontal direction in accordance with the first optical apertures and giving image segments obtained by interleaving perspective projected images in the vertical direction.

The invention further provides a three-dimensional display image data generating method used as a method for arranging horizontal parallel projected images separately in accordance with the pixel columns and arranging images obtained by interleaving perspective projected images in the vertical direction, the method including a process for applying a perspective projection matrix to a point (x, y, z) in a space of objects as computer graphics data, a process for dividing each matrix element except the coordinate xby (1−z/d) (in which d is the coordinate of the center of projection), and the step of repeating the processes a plurality of times in accordance with the positions of view points.

When such algorithm is used, an image parallel projected in the horizontal direction and perspective projected in the vertical direction can be obtained very easily.

Incidentally, the concept “optical apertures” used in this specification does not mean only apertures but includes slits, apertures, lens elements or diffraction gratings which are optical segments for controlling light rays optically.

### EFFECT OF THE INVENTION

As described above in detail, in the stereoscopic display device according to the invention, a natural and high-definition stereoscopic image can be observed in accordance with the observer's motion in horizontal and vertical directions.

### BRIEF DESCRIPTION OF THE DRAWINGS

The present invention may be more readily described with reference to the accompanying drawings:

FIG. 1 is a plan view schematically showing arrangement in a horizontal plane of a three-dimensional image display device according to an embodiment of the invention;

FIG. 2 is a plan view schematically showing arrangement in a vertical plane of the three-dimensional image display device according to the embodiment of the invention;

FIG. 3 is a perspective view schematically showing the three-dimensional image display device depicted in FIGS. 1 and 2; and

FIG. 4 is a flow chart showing a procedure for generating an image to be displayed on a display panel depicted in FIGS. 1 to 3;

FIG. 5 shows a relation of coordinate axes (X, Y, Z), an object, a projection plane and the center of projection;

FIG. 6 shows a coordinate of a point acquired as a result of operation on the X-Y plane;

FIG. 7 shows a coordinate of a point acquired as a result of operation on the Y-Z plane;

FIG. 8 is a plan view schematically showing arrangement in a vertical plane of the three-dimensional image display device according to the embodiment of the invention.

### DETAILED DESCRIPTION OF THE INVENTION

A stereoscopic display device according to embodiments of the invention will be described below in detail with reference to the drawings.

(First Embodiment)

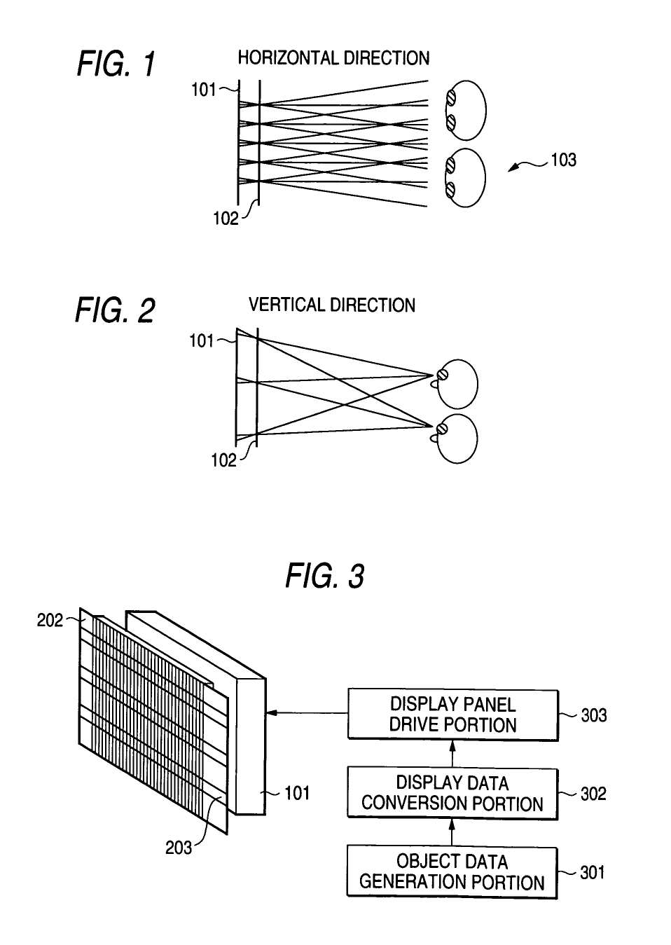

A stereoscopic display device according to a first embodiment of the invention will be described with reference to FIGS. 1 and 2.

FIG. 1 is a plan view schematically showing arrangement in a horizontal plane of the stereoscopic display device according to the first embodiment of the invention. FIG. 2 is a plan view schematically showing arrangement in a vertical plane of the stereoscopic display device according to the first embodiment of the invention. As shown in FIGS. 1 and 2, the stereoscopic display device has a liquid crystal panel 101 provided as a planar display device for displaying element pixels of an image to be stereoscopically displayed, and a parallactic barrier 102 (light ray control portion) for controlling light rays emitted from the liquid crystal panel 101. A direct-view or projection liquid crystal display device, a plasma display device, a field emission display device, an organic EL display device or the like may be used as the liquid crystal panel 101 if the liquid crystal panel 101 is of the type in which pixels are stationarily disposed in the form of a matrix.

The stereoscopic display device shown in FIGS. 1 and 2 has a diagonal length of 20.8 inches and a size of 3200 pixels (horizontally) by 2400 pixels (vertically) when the stereoscopic display device is of a direct-view type. Each pixel is vertically separated into three sub pixels, namely, red, green and blue (RGB) sub pixels. That is, each pixel is composed of red, green and blue (RGB) sub pixels which are arranged vertically continuously. A pitch between adjacent ones of the sub pixels used is selected to be 44 μm. A slit or lenticular lens (optical aperture) array substantially extending vertically and substantially having a cyclic structure in the horizontal direction (horizontal plane) is used as the parallactic barrier. The horizontal pitch (cycle) of the slits can be set at 0.704 mm which corresponds to sixteen sub pixels accurately. The gap between a display surface (glass substrate inner surface) of the liquid crystal panel provided as a display device and the parallactic barrier can be set at about 2 mm effectively in consideration of the refractive indices of the glass substrate and the lens material. Generally, this technique in which the actual pitch (which is not the apparent pitch based on the difference in distance) of the parallactic barrier is equal to an integer multiple of the pixel pitch is not multi-view but one-dimensional integral imaging, as described above. In the arrangement shown in this example, light rays converge in the neighbor of the display panel 101 but eyes are not practically disposed in the convergent position. Moreover, the interval of convergence is not equal to the distance between the eyes. In addition, light rays do not converge in any other view distance than the neighbor of the display panel 101. Accordingly, the arrangement in the horizontal plane as shown in FIG. 1 is not classified into a multi-view technique but classified into a one-dimensional integral imaging technique. In the one-dimensional integral imaging technique, the image varies according to the view point position because parallax occurs in the horizontal direction.

On the other hand, in the vertical direction (vertical plane) as shown in FIG. 3, a line connecting the view point position and the aperture center to each other passes through the pixel center. That is, in the vertical plane, the vertical pitch of the apertures is not equal to an integer multiple of the pixel pitch. In the horizontal plane, the pitch of element images (i.e. images given to pixel groups) is equal to an integer multiple of the pixel pitch.

As shown in FIG. 3, a lenticular lens sheet 202 is used in place of the slit array as a light ray controller in the horizontal direction (horizontal plane). A slit array 203 having a plurality of openings is used as a light ray controller in the vertical direction (vertical plane). That is, the lenticular lens sheet 202 and the slit (optical aperture) array 203 form the parallactic barrier 102. For example, the pitch of the slits (optical apertures) is set at a value slightly smaller than 528 μm which corresponds to four pixels. According to this setting, light rays can be converged in the neighbor of the view distance with respect to the vertical direction. In this case, light rays converge at four places in the vertical direction but one image can be viewed from the neighbor of a convergent point with respect to the vertical direction. For this reason, the image from the nearest convergent point can be viewed while switched in accordance with the vertical position of the observer's head. In the stereoscopic display device having this structure, a natural stereoscopic image can be observed even in the case where the observer moves horizontally and vertically.

(Second Embodiment)

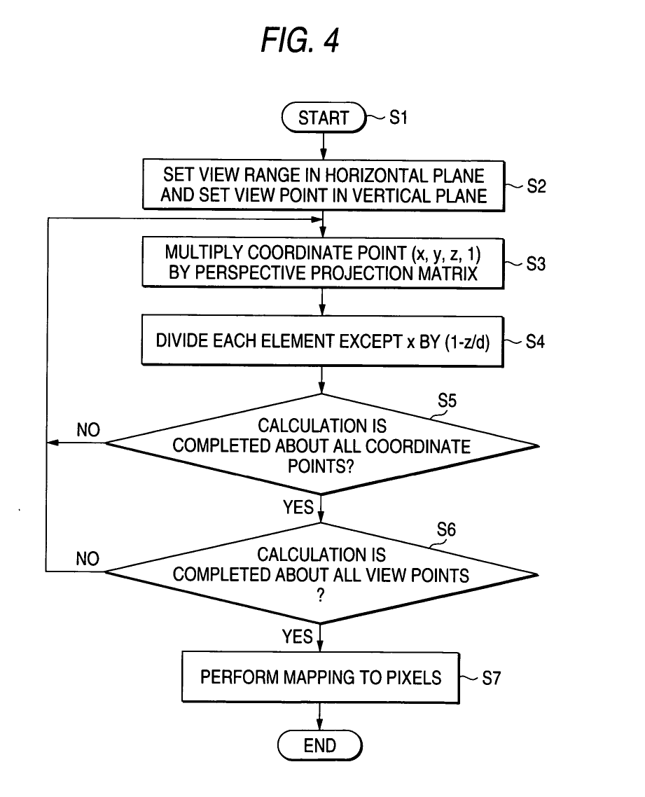

The image to be displayed on the display panel 101 can be generated by use of computer graphics. That is, for example, as shown in FIG. 3, an object data generation portion 301 has a graphic generator for generating object data (polygon data), and a not-shown memory for storing the object data. The object data are supplied to a display data conversion portion 302. In the display data conversion portion 302, vertical perspective is projected and horizontal parallel projected images corresponding to the number of parallax components are generated on the basis of the object data. In the display data conversion portion 302, points (x, y, z, 1) on an object data space can be converted into horizontal parallel projected and vertical perspective projected points in the following manner to generate data to be displayed on the display panel 101. Here, x, y, and z are orthogonal coordinates of the point, the x-axis is horizontal and they-axis is vertical, both of which are parallel to the display panel, and the z-axis is perpendicular to the display panel. The procedure of processing in the display data conversion portion 302 shown in FIG. 3 will be described with reference to FIG. 4.

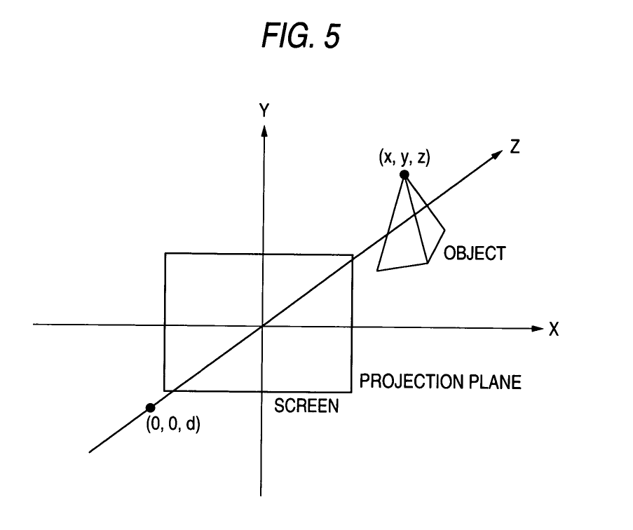

Processing starts at step S1. First, in step S2, a view range is set in the horizontal plane and a plurality of view points (e.g. three or four view points) are set in the vertical plane. After the settings are completed, object data are supplied to the display data conversion portion 302. An arithmetic operation starts with respect to one view point in the view range which has been already set. That is, in step S3, a point (x, y, z, 1) in the object data is multiplied by the perspective projection matrix represented by the following expression (1). A point (x, y, 0, 1−z/d) is obtained by this arithmetic operation. In the expression (1), d expresses the coordinate of the center of projection. FIG. 5 shows a relation of coordinate axes (X, Y, Z), the object, a projection plane, and the center of projection.

Specifically, the perspective projection matrix is as follows.

$${[ \begin{matrix}1 & 0 & 0 & 0 \\ 0 & 1 & 0 & 0 \\ 0 & 0 & 0 & - 1 / d \\ 0 & 0 & 0 & 1\end{matrix} ]}_{Perspective Projection Matrix} \qquad [ Expression 1 ]$$

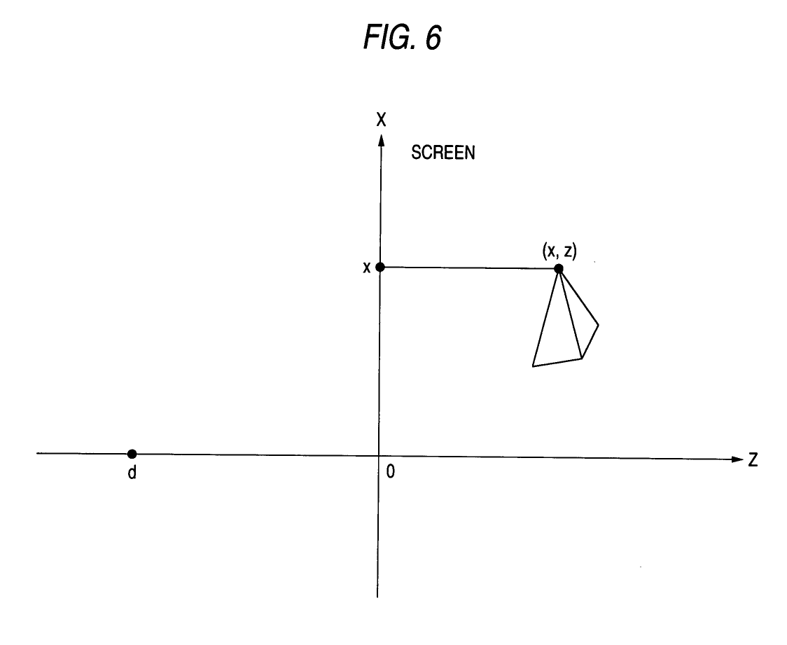

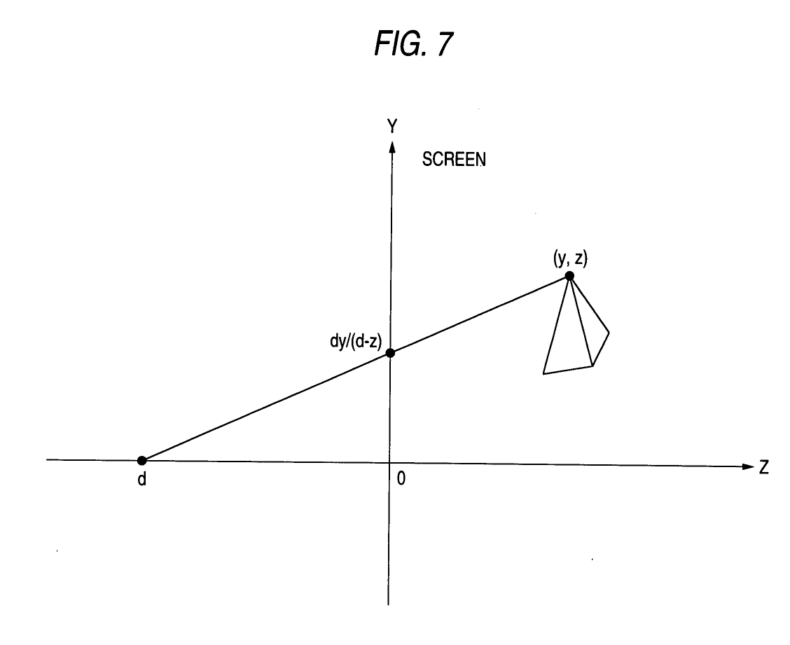

In succession to this arithmetic operation, each element except x is divided by (1−z/d) as shown in step S4. A point (x, dy/(d−z), 0, 1) is obtained by this arithmetic operation. The result of the arithmetic operation is equivalent to the coordinates of a point in which the point is parallel projected in the horizontal direction (horizontal plane) and perspective projected in the vertical direction (vertical plane). The arithmetic data are stored in the not-shown memory. FIGS. 6 and 7 show the coordinates of the point acquired as a result of operation on the X-Y plane and the Y-Z plane, respectively.

Then, in step S5, completion of the arithmetic operations in steps S3 and S4 on all points (x, y, z, 1) in the object data is checked. When the arithmetic operations in steps S3 and S4 have not been completed yet, the steps S3 and S4 are repeated. When the arithmetic operations in steps S3 and S4 have been already completed in step S5, a judgment is made in step S6 as to whether the arithmetic operations are completed on all view points or not. When the step S6 makes a decision that there are still some view points on which the arithmetic operations have not been completed yet, the arithmetic operations on a new view point start. That is, the arithmetic operations in the steps S3 to S5 are repeated while the view point position in the vertical direction (vertical plane) is changed. When the arithmetic operations have been already completed on all view points, mapping is performed from a plurality of images stored in the memory to pixels to thereby obtain an image to be displayed on the panel 101. That is, image data to be distributed into pixels on the display panel 101 are decided. The image data are stored in a frame memory (not shown) which is used for storing one frame. The image data are supplied to a display panel drive portion, so that one frame of image for stereoscopic view is displayed on the display panel 101. When a plurality of pieces of frame data are prepared, a motion image capable of being stereoscopically viewed can be displayed on the display panel. Images necessary for stereoscopic display can be obtained in such a simple method, so that a stereoscopic motion image can be displayed by the stereoscopic display device.

Incidentally, the invention is not directly limited to the embodiments but various changes of constituent members may be made in the stage of carrying out the invention without departing from the gist of the invention.

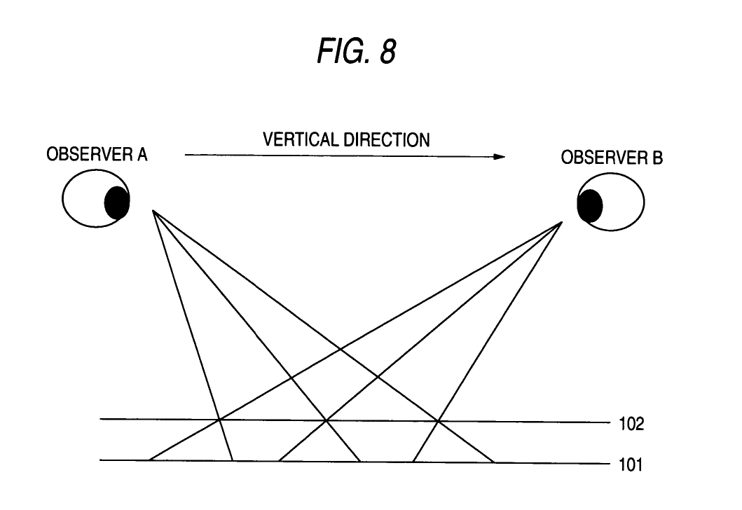

For example, as shown in FIG. 8, it may set a show direction of the display panel 101 into up direction. With this composition, it is set up to so that light rays may make it converge in the viewpoint position where Observer A differs from Observer B, and a three-dimensional image is displayed simultaneously in the view point position of Observer A and observer B. In this case, the three-dimensional images observed by Observer A and Observer B may be either the same three-dimensional image or different three-dimensional images. Moreover, even if the three-dimensional images displayed in the viewpoint positions of Observer A and Observer B are the same three-dimensional image, Observers may make it display the three-dimensional image (180 degrees when meeting) reversed, respectively. With such composition, a three-dimensional image can be observed simultaneously, without two observers who meet changing a viewpoint.

The plurality of constituent members disclosed in each of the embodiments may be combined suitably to form various modifications of the invention. For example, several constituent members may be removed from all the constituent members described in each of the embodiments. In addition, the constituent members used in the different embodiments may be combined suitably.

1. A three-dimensional image display device comprising:
a display portion including pixels arranged in the form of a matrix in a planar display surface to have fixed horizontal and vertical pitches;
a light ray control portion including first optical apertures arranged in front of the display portion to have a first pitch in a horizontal direction configured to control light rays emitted from the pixels in the horizontal direction, and second optical apertures arranged in front of the display portion to have a second pitch in a vertical direction configured to converge the light rays at a certain view distance in the vertical direction; and
a display drive portion configured to give element images generated based on parallel projected images to a plurality of pixel groups along the horizontal direction in accordance with the first optical apertures, and to give image segments obtained by interleaving perspective projected images in the vertical direction,
wherein the first pitch is decided to be equal to an integer multiple of the horizontal pitch of the pixels, and the second pitch is decided to be smaller than an integer multiple of the vertical pitch of the pixels.

2. The three-dimensional image display device according to claim 1,
wherein the first optical apertures are provided as a lenticular lens sheet while the second optical apertures are provided as a slit array.

3. The three-dimensional image display device according to claim 1,
wherein the display drive portion includes:
a first processing portion configured to apply a perspective projection matrix to a point with coordinates (x, y, z) in an object to be displayed;
a second processing portion configured to divide each matrix element except the coordinate x by (1−z/d), d being a coordinate of a center of projection; and
a third processing portion configured to repeat processing in the first and second processing portions a plurality of times while changing a convergent position.

4. A three-dimensional image display method used in a three-dimensional image display device including:
a display portion having pixels arranged in the form of a matrix in a planar display surface to have fixed horizontal and vertical pitches, and
a light ray control portion having first optical apertures arranged in front of the display portion to have a first pitch in a horizontal direction configured to control light rays emitted from the pixels in the horizontal direction, and second optical apertures arranged in front of the display portion to have a second pitch in a vertical direction configured to converge the light rays at a certain view distance in the vertical direction, the first pitch being decided to be equal to an integer multiple of the horizontal pitch of the pixels, and the second pitch being decided to be smaller than an integer multiple of the vertical pitch of the pixels,
the method comprising:
giving element images generated based on parallel projected images to a plurality of pixel groups along the horizontal direction in accordance with the first optical apertures; and
giving image segments obtained by interleaving perspective projected images in the vertical direction.

5. The three-dimensional image display method according to claim 4,
wherein the first optical apertures are provided as a lenticular lens sheet while the second optical apertures are provided as a slit array.

6. The three-dimensional image display method according to claim 4, further comprising:
applying a perspective projection matrix to a point with coordinates (x, y, z) in an object to be displayed;
dividing each matrix element except the coordinate x by (1−z/d), d being a coordinate of a center of projection; and
repeating the applying and the dividing a plurality of times while changing a convergent position.

7. A three-dimensional display image data generating method used as a method to arrange horizontal parallel projected images separately in accordance with pixel columns, and to arrange images obtained by interleaving perspective projected images in a vertical direction,
the method comprising:
applying a perspective projection matrix to a point with coordinates (x, y, z) in an object as computer graphics data;
dividing each matrix element except the coordinate x by (1−z/d), d being a coordinate of a center of projection; and
repeating the applying and the dividing a plurality of times in accordance with a positions of a view point.
